(19) United States
(12) Patent Application Publication
(10) Pub. No.: US 2010/0289783 A1
(43) Pub. Date: Nov. 18, 2010

(54) SENSOR FOR MEASURING LIGHT INTENSITY AND THE PROCESS OF CALIBRATING A MONITOR

(76) Inventor: Marc Leppla, Braunschweig (DE)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/697,730

(22) Filed: Feb. 1, 2010

(30) Foreign Application Priority Data
May 15, 2009 (DE) 102009021375.9

(51) Int. Cl. G09G 5/00

(52) U.S. Cl. 345/207

(57) ABSTRACT

The invention is directed to a sensor for measuring light intensity. In one embodiment, the sensor includes a light sensor and an assembling device for attaching and allowing the dismantling of the sensor to a monitor wherein the sensor measures the light intensity generated by the monitor's screen. In another embodiment, the sensor may include an assembling device that connects to a monitor through mould-based connection or magnetic connection. In various embodiments the sensor may also include a linking device and an electronic control device wherein the linking device transmits the measurement data of light intensity to the electronic control device and has an operating radius that is large enough as to allow the positioning of the sensor on any part of the monitor's screen.

### RELATED APPLICATIONS

The present application claims the benefit of German Application No. 102009021375.9, filed May 15; 2009, which is incorporated herein in its entirety by reference.

### FIELD OF THE INVENTION

The invention relates to a sensor for measuring light intensity. More specifically the invention relates to sensors that can be used for measuring a light quantum, brightness, light density or coloring.

### BACKGROUND OF THE INVENTION

Most high end medical monitors have a sensor attached to the frame that measures constantly the light density of the screen. This way, one can identify prospect changes of the brightness caused by obsolescence, which can be easily offset. When screens become obsolete, such situations can occur differently in various areas. This means that the uniformity of the screen is affected and the quality decreases. The result is that an image that should be displayed uniformly will be displayed with various brightness levels. In case the lack of uniformity overcomes the value of the set parameter, the monitor will have to be replaced with a new one. For this reason, the uniformity should be measured regularly.

The disadvantage of current systems is that establishing uniformity is quite pricy and should be performed by specialized staff. Another inconvenient is the fact that the lack of uniformity between the center of the screen and the margins set during the manufacturing process can change in time. If the margin light quantum is chosen as a reference standard for monitoring the center light quantum, this could easily lead to various errors.

According to U.S. Pat. No. 7,064,831 B2, we learn that a chromatometer can be relatively adjusted to a screen, due to its adaptable weight while gliding. The disadvantage of chromatometers is that they are not suitable for monitoring a screen on a long-term.

According to U.S. Pat. No. 6,067,166 we learn about an assembling device for chromatometers that looks like a stripe framing the monitor. Not even this device is suitable for monitoring constantly the monitor's characteristics.

Thus, there exists a need for a light intensity sensor and system and method of establishing uniformity that is cost-effective and easy to use along with being durable and long-lasting.

### SUMMARY OF THE INVENTION

The purpose of this discovery is that the monitors used for image representations in medicine are subjected to special requirements during the calibration process. In order to render the image representations with a constant quality, such monitors should be disposed and calibrated correctly. Quality standards such as the German DIN V6868-57 and the American AAPM TG 18 describe in detail how to calibrate each parameter of the screen and they set the necessary data for future checkups of the set parameters.

The invention solves the problem using a sensor for measuring light intensity. It includes an assembling device that was created specifically for attaching the dismantling sensor on the monitor, such as to measure the light intensity of the monitor using this sensor from its fixed position.

According to the second issue presented above, the invention solves the problem through a calibration process of the monitor following the steps:

(i) Positioning the sensor according to the invention's indications;

(ii) Rendering images on the screen such as to identify the sensor's position of the screen based on the light quantum measured by the sensor;

(iii) Intercepting the sensor's signal in relation to time;

(iv) Identifying the sensor's position o the screen using the signal;

(v) Identifying the screen's light quantum (I) in the position (P1).

One advantage of the sensor is that it can be attached on a monitor that functions continuously. For example, the sensor was created to allow attachment on the corner of the screen. This way, the sensor can monitor brightness, meaning the screen's light density. The sensor can also be dismounted, allowing the user to attach it in any position, in order to measure the uniformity of the screen. Thus, this procedure can be performed by any regular user of the monitor, consequently leading to lower expenses.

Another advantage of the sensor is that it is detachably connected to the monitor and thus, is easily calibrated. All you have to do is remove the sensor from the monitor's screen and mount it into a calibration device.

In addition, the sensor can be replaced easily. This makes it possible to quickly replace faulty sensors. In addition, in certain embodiments, the backlight sensor is dispensible. All the above advantages can be achieved with a simple technical expense. For example, it's enough to attach a gliding rail along the margins of the monitor; the sensor can be attached on any position on this gliding rail.

One benefit of the procedure related to this invention is that any user can easily perform all the actions required with no previous training. Therefore, it is feasible that all the steps of the process can be automated. Only the changing of the position of the sensor is preferably carried out manually, although it can also be automated. As a result, the monitor can be easily checked when it comes to its radiance or emission properties, thereby avoiding errors caused by the change of the properties over time. Thus, even mass-produced monitors that don't fulfill the requirements related to the consistency of the radiance and emission properties can be used for applications that specifically require such consistency. For example, common monitors can be used for rendering medical applications.

One last advantage is that one can send a command from a central computer, which will launch a configuration program on one or more monitors. The program may assist in the calibration by asking the user to position the sensor at predetermined locations on the screen. It can be set that the normal functioning of the monitor restarts after the application is closed. Therefore, in various embodiments, by using a computer network or the Internet you can determine radiance and emission properties and calibrate a large number of monitors without hiring professional staff.

In various embodiments, the sensor may include an assembling device, created for the attachment and dismounting of the sensor on/from a monitor. Thus, the sensor, using the assembling device, can be attached to the monitor frame and maintain its position permanently respective to the monitor screen. In other embodiments, the sensor can be dismounted from the frame, and then it can be reattached.

From the disclosure above that indicates the feature of the sensor that allows it to measure the light intensity of a monitor's screen we learn specifically that the attached sensor provides the screen with a sensorial cell that can be used to intercept the light emitted by the screen.

By sensor for measuring light intensity we refer specifically to a brightness sensor, color sensor, chromatometer, a spectrophometer, or a brightness meter.

By light quantum, also defined as a brightness property, we refer to a measurable property of light. This represents specifically brightness (for example in cd/m²), light intensity and/or luminance, and brightness of a color like red, green or blue (for example in cd/m²), or one of the other colors included in the light spectrum. The measurements are commonly represented as variables such as YXZ, yxY and/or spectral values.

By assembling device we refer to a device that allows attaching the sensor in relation to the screen, in a way that allows setting the sensor in a fixed position in relation to the screen.

By monitor we refer to the entire device where the screen represents the part of the monitor used for displaying images.

By medical display device we refer to a device formed by at least two monitors, used for rendering images of the human body, parts of the human body or animal body. For example, a medical display device can be linked to a digital radiology device and calibrated to display X-ray pictures.

Monitors used specifically for medical purposes are generally subjected to very high demands when it comes to image uniformity and homogeneity, because for example, tumors can only be identified on the X-rays through brightness differences. An increased lack of uniformity of the monitor can lead to a situation when the screen will display a contrast that doesn't exist in reality. In this situation, a false positive diagnosis of cancer could arise.

According to one embodiment, the assembling device can be attached to the monitor through positive force or magnetic connection. Thus, either a tight-fit or magnetic connection will provide solid and durable junctions, dismountable between the monitor and the sensor. In one embodiment the assembling device is created for attaching the sensor to the monitor's frame. For example, the assembling device includes a set of rails that can be attached on the frame near the corner of the screen.

According to another embodiment, the sensor has a shielding device, created for shielding the sensor from diffuse light, especially when the sensor is mounted to the monitor. In this way, the sensor provides an accurate determination of the amount of light emitted by the screen. For example, if you display a standardized grey measure on the screen, then based on the value measured with the sensor, it can be determined if the screen renders the required brightness.

According to another embodiment, the sensor includes a connecting device for transmitting the measurement data of light quantum from the sensor to an electric control unit. In this case, the connecting device has an operating radius large enough to allow the positioning of the sensor in any position on the screen. By operating radius we refer to the range that can be covered by the sensor when detached from the fixed position on the monitor. The connecting device can be, for example, a cable. In this situation, the sensor's operating radius corresponds to the length of the cable. In another embodiment, the connecting device may utilize a wireless connection to transfer data.

According to various embodiments, the system includes a screen for displaying images and a sensor that is used for detecting light intensity which is detachable attached to the monitor.

In another embodiment, the monitor has a frame that surrounds the screen, at least partially, in which the sensor is mounted in a corner of the frame. The frame may also be called a pretzel. It is possible, but not necessary that the sensor is mounted exactly in the corner of the frame. It is also possible that it is arranged at a small distance from the corner.

According to one embodiment, the sensor's range of action corresponds to at least one width of the screen, or more specifically, to the screen's diagonal. This way, one can make sure that the sensor covers all areas of the screen. Further, in various embodiments, the sensor covers a screen surface that is a small percentile of the entire screen area. Therefore, the sensor affects the overall use of the monitor insignificantly.

According to one embodiment, medical display equipment is formed by a first monitor and a second monitor. In various embodiments, it is possible, but not mandatory, that the first and/or the second monitor to be monitors perfectly compatible with the invention.

According to one embodiment, the medical display equipment contains an electric control device that is disposed for rolling off a process following the next steps:

(i) Displaying the image on the screen of one of the two monitors in positions that can be modified in time;

(ii) Capture the sensor's signal in relation to time;

(iii) Identifying the sensor's position on the screen from the signal;

(iv) Capture at least one light intensity reading of the screen at the set position;

(v) Repeat steps (i) to (iv) for at least another position so as to obtain the screen's radiation or emission pattern.

In one embodiment, radiation or emission may be considered as, a homogeneous brightness of a color, multiple colors or a spectrum. In various embodiments, the control device includes a digital memory that stores executable program code, such as code allowing the execution of the steps disclosed above. The executable program code provides instructions to the control device, thereby allowing the steps to be performed automatically.

In certain embodiments, in order to restart steps (i) to (iv) the sensor has to be moved in another position in relation with the screen, where it can be secured or reattached, or held by hand, to the screen.

In various embodiments, the control device can be part of one of the two monitors, part of a sensor, part of a computer system or an external control device. For example, the control device may be part of a personal computer that can be used to simultaneously drive the two monitors.

In certain embodiments, during a procedure compatible with the invention it is recommended to repeat the steps for at least another position, different from the initial one. It will result in different values of light intensity which can be used for computing the uniformity of the screen.

In various embodiments, the emission pattern represents the uniformity of the screen. In these embodiments, the process will include the stage of screen control, thereby reducing screen uniformity. If, for example, a homogeneous image being displayed on the monitor is not homogeneous, but displayed with different magnitudes due to monitor aging, it is preferable to correct it by adjusting the monitor based on a set brightness value and measured brightness at several positions on the screen. In various embodiments, using the plurality detected brightness values; one can calculate a correction factor matrix that generates correction factors for individual areas of the screen. The correction factor matrix may also indicate how brightness must be controlled, either stronger or weaker, so as to allow for the adjustment to the desired brightness.

In various embodiments, the process compatible with this invention can be started if the sensor is dismounted from the monitor and attached in any fixed position of the screen. Subsequently the control device will start rolling off all the steps (ii) to (v) described above. In this way, the position of the sensor on the screen is known. Thus, in various steps, one will measure the light intensity according to the established position.

In various embodiments, the sensor can be reattached to the monitor, for example, in one of the corners, allowing continuous monitoring of the brightness or color intensity. Thus, in various embodiments, one sensor can be utilized to measure brightness, color and screen homogeneity.

In certain embodiments, the procedure compatible with this invention includes a step for controlling both the first and the second monitors in order to avoid lack of uniformity between the two and for balancing any differences of uniformity. For example, in one embodiment, the system and method is utilized to measure the brightness levels of the screens that are set on white (driving level 255). In various embodiments, a higher brightness is not controllable. Thus, in one embodiment, users utilize the sensor to measure the brightness levels from several positions, on both monitors separately. The control device may then determine the lowest values obtained from the measurement. In the further operation of the two monitors, all pixels of the screens are controlled such that, if present, the white color is exactly like the brightness, as it corresponds to the minimum brightness levels. This way, the contrast levels are always correct, even when the maximum brightness has decreased in some areas of the monitors.

### BRIEF DESCRIPTION OF THE DRAWINGS

FIG. 1 is a view of medical display equipment compatible with the invention with a first monitor, a second monitor and a sensor, all compatible with the invention;

FIG. 2 is a detailed view of the first monitor with a sensor compatible with the invention;

FIG. 3 is a sectional view of the monitor, across the frame of the monitor;

FIG. 4 is a topside view of the sensor from FIG. 2;

FIG. 5 is a sectional view of the sensor, face-on with the screen;

FIG. 6 is a schematic depiction of both monitors included in the medical display equipment with approximate measured intensities; and

FIG. 7 is a schematic diagram showing how, during a procedure compatible with the invention, one can determine a target color gamut from two different gamut's for the measured values of CIE/x/y/Y for two screens.

### DETAILED DESCRIPTION OF THE DRAWINGS

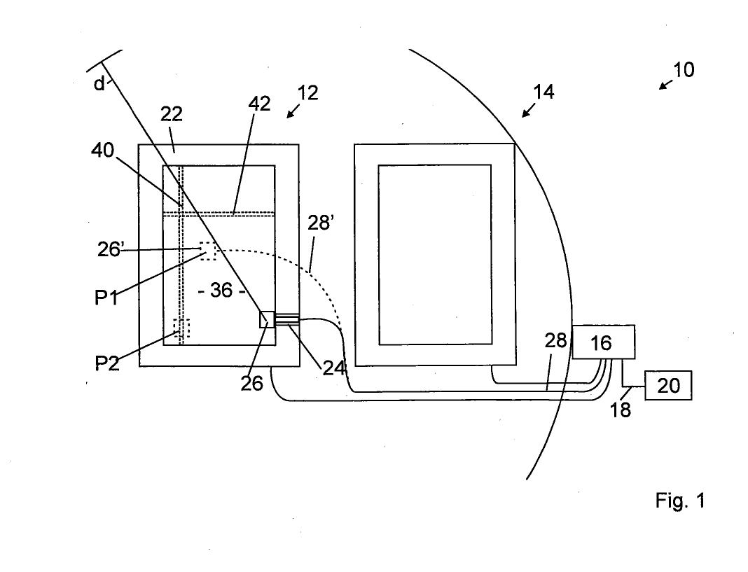

FIG. 1 presents the medical display equipment 10, including the first monitor 12 and a second monitor 14, and also a control device 16 represented by a computer, according to one embodiment. Both monitors 12, 14 are connected through cable to the control device 16 represented by a computer, which controls the display of images. The computer 16 is connected through a network 18 with a server 20.

The first monitor 12 is enclosed by a frame 22. A receptacle 24 is attached to the frame 22 using glue, for example. The receptacle 24 has a shape of a rail, where a sensor 26 can be inserted. The sensor 26 is connected to the computer 16 using a connecting device 28 such as a USB cable. The connection device 28 has a cable length so as to allow the sensor to reach all positions on the first 12 and second 14 monitors.

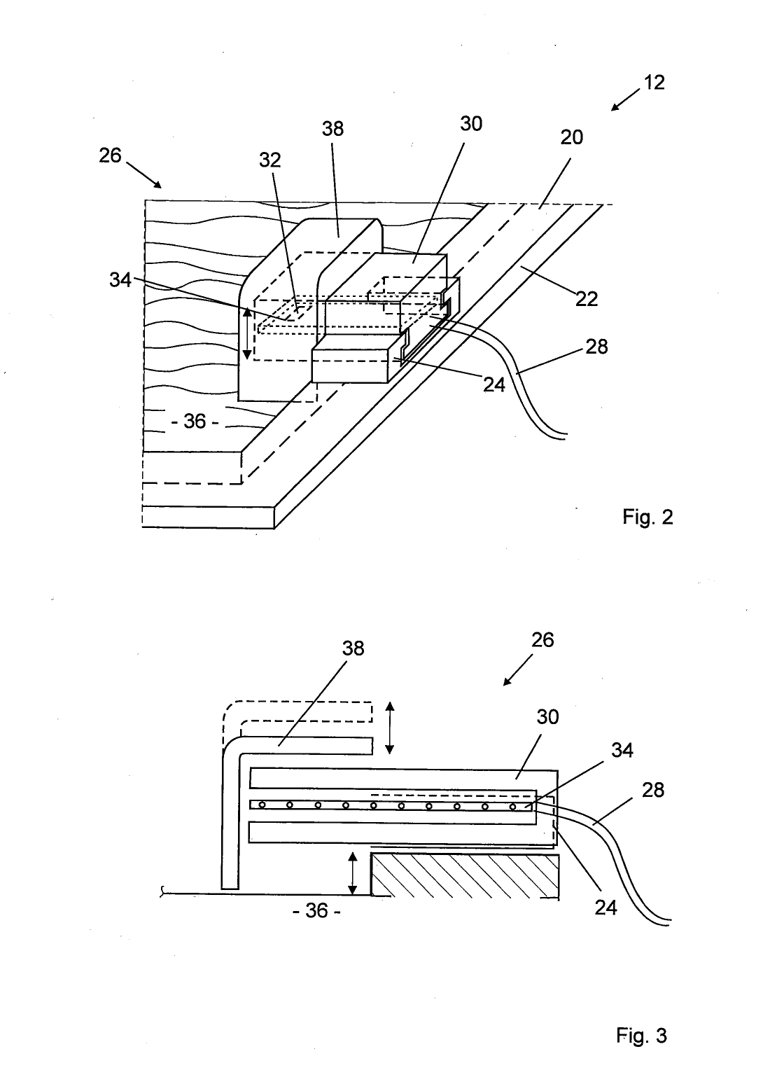

FIG. 2 represents the sensor 26 including a mounting device 30 that can be attached to the receptacle 24 various forms of connection such as positive or magnetic force or may be attached in a fixed state, according to various embodiments. The sensor 26 includes a sensorial cell 32 which is disposed on a circuit board 34. In various embodiments where the sensor is connected to the first 12 or second 14 monitor, the sensorial cell faces the monitor's 12, 14 screen 36. In various embodiments a light shield 38 prevents stray light from reaching the sensorial cell 32. In this way, the information captured by the sensorial cell 32 is generated solely by the screen 36.

FIG. 3 presents a cross-cut section of the sensor 26 perpendicular to the screen 36 according to one embodiment. You can see that the light shield 38 is mounted to the mounting device 30 but is capable of vertical adjustments, thereby allowing the light shield 38 to move towards and away from the screen 36. For example, in one embodiment, light screen 38 is designed to allow for vertical adjustments of at least 1 cm.

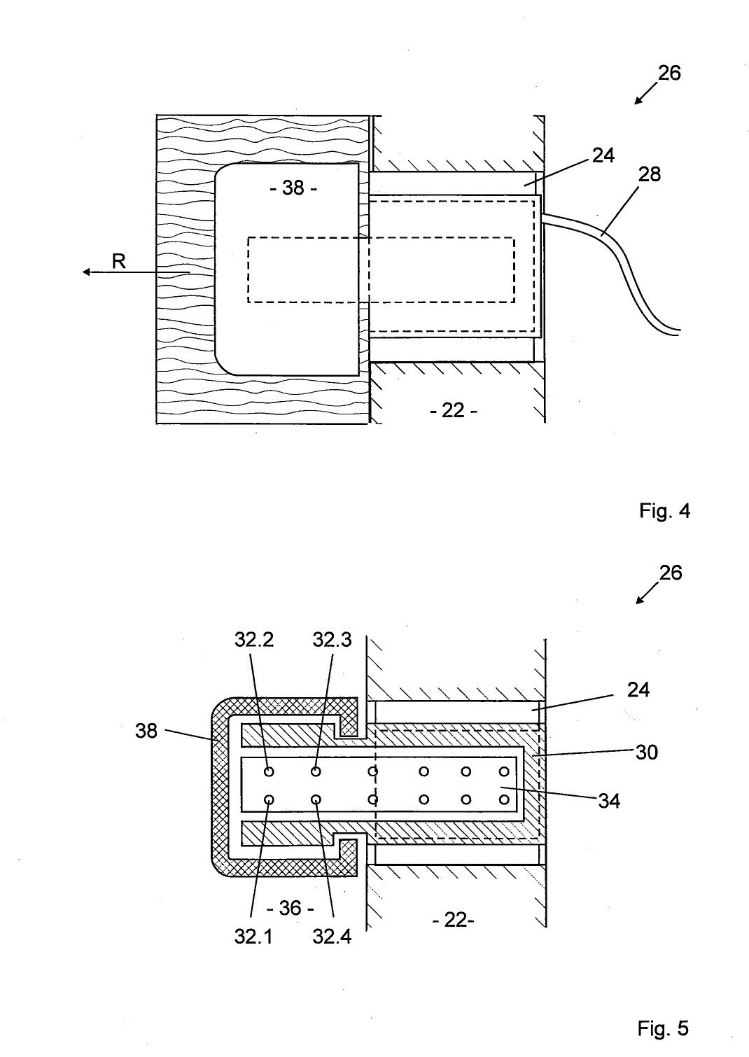

FIG. 4 presents a topside view of the sensor 26 according to one embodiment. For dismounting the sensor 26 from the frame 22, the sensor, indicated by the R arrow, will be dismounted from the support 24 built in form of a rail. The sensor 26 is still connected to the computer 16 using the connection device 28.

FIG. 5 presents a cross-cut section through the sensor 26 according to one embodiment. The light shield 38 may fit in a recess of the mounting device 30. Further, FIG. 5 presents schematically, that in one embodiment, the circuit board 34 includes four sensorial cells 32.1, 32.2, 32.3, and 32.4. The first sensorial cell 32.1 has a red filter, the second cell 32.2 a green filter and the third sensorial cell 32.3 a blue filter. The fourth sensorial cell 32.4 has no filter and may be used for measuring brightness and luminance. The sensor 26 can be used as a colormeter and as a brightness/luminance meter. Alternatively, or in addition to, the sensor cells 32.1, 32.2, 32.3, 32.4, various embodiments mount a prism between the screen 36 and the cells thereby measuring the color spectrum emitted by the screen 36.

In various embodiments, for starting a process compatible with the invention, the sensor 26 will be separated from the first monitor 12. Afterwards, it will be positioned manually or automatically using a mounting device (not shown) on a first dashed line in FIG. 1, position P1.

The computer 16 controls the first monitor 12 such as to display a vertical band 40, so that the band is shown moving from left to right in remitting strips 40 (FIG. 1) on screen 36. The sensor 26 in position P1 26′ sends a real-time signal through the connecting device 28′ that encodes a metric size of the light quantum as brightness values. After the band moving from left to right passes the P1 position, the sensor 26′ detects an increased value. The value decreases again as the band 40 moves across the screen 36. Based on the measured change in brightness and other metics such as data and time, the computer 16 determines determine the ‘x’ coordinate of position P1.

Following, the computer 16 controls the first monitor 12 such as to display a band 42 moving up and down the screen 36 in order to determine accordingly the ‘y’ coordinate of the position P1. It is possible to display on the screen 36 two or more bands of different colors. From the moments when the device identifies the intensity changes, one can calculate the position P1.

In one embodiment, if position P1 is determined, which appears, for example, at least partially in the center of the screen 36, a pre-established brightness value will be set at least for the position P1 in the center of the screen 36. For example, in various embodiments, the brightest white that can be displayed by the screen 36 will be set at position P1. The brightness/luminance value will then be read by the sensor 26 at position P1 and sent to the computer 16. In various embodiments, we refer by the center of the screen 36 to the area of the screen 36 that represents a quarter of the entire screen size and whose geometrical weight center corresponds to the one of the entire screen.

After receiving the brightness/luminance measurement for the position P1, the computer 16 will send an acoustic and/or optic signal to instruct the user to position the sensor 26 in a second position, such as position P2, at the margin of the screen. In various embodiments, the margin of the screen represents all areas that are not part of the center of the screen. Utilizing the process described above, the exact position P2 on the screen 36 is determined, and brightness/luminance is measured. In several embodiments, the process is repeated for a variety of positions Pi, where i=1, 2, 3. . . and so on. For each position Pi a light quantum Li, for example a light intensity Ii or brightness, is measured.

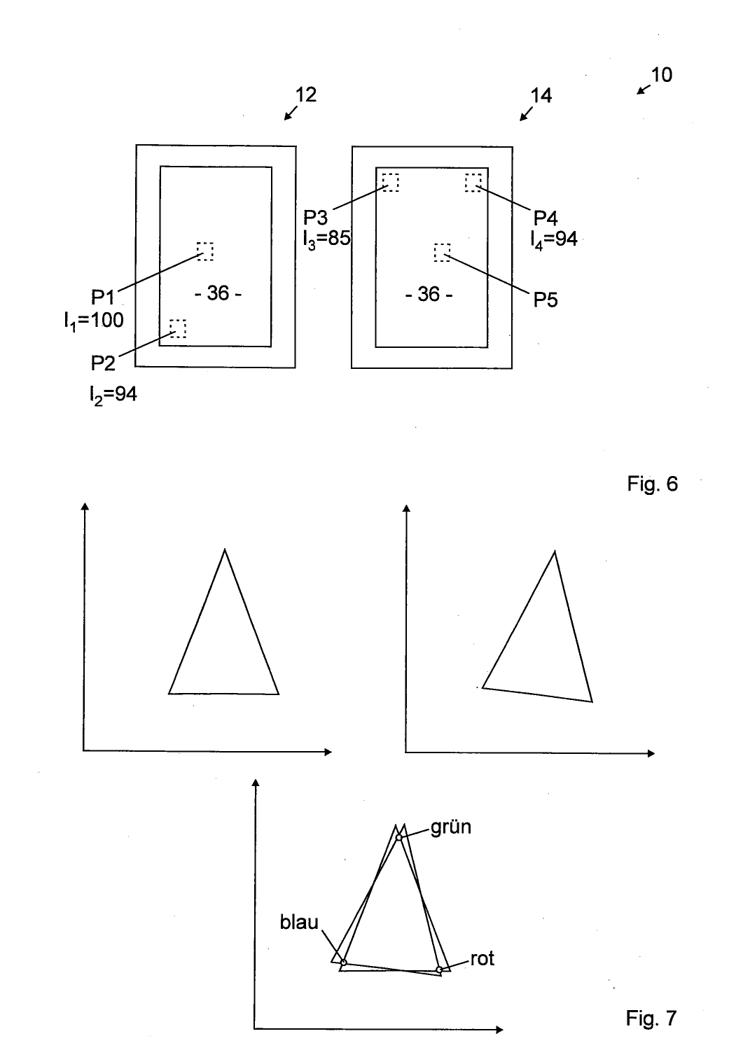

FIG. 6 indicates schematically one embodiment having a first monitor 12 and a second monitor 14 with measured brightness values in five set positions, all normalized to 100. The highest measured value is what you will normalize settings to and thus, in this embodiment, 100 is measured at position P1 on the screen 36 of the first monitor 12. You will notice that the lowest value obtained, I3 =85, corresponds to the position P3 on the second monitor's 14 screen 36, top left corner. Therefore, the minimum value of light intensity ‘I’ is 85.

In various embodiments, for each position Pj, the computer 16 will calculate the division:

$$\text{?} \frac{min \text{?}}{I \text{?}}$$

$$\text{?} \text{indicates text missing or illegible when filed}$$

In one embodiment, for example, the intensity in the form of luminance L will be measured in candela per square meter (cd/^{m}^{²}).

In various embodiments, a graphics card of the computer 16 is automatically programmed so that the pixels that belong to the position of Pj, for example, are controlled on the qj-fold value. Hence, if, for example, a completely white image on the screen 36 are shown, the pixels at the position P3 are controlled such that they provide the maximum brightness, as q3=85/85=1 holds. The pixels are at the P1 position, however controlled so as to deliver 0.85 times the brightness, since q1=85/100=0.85 holds. The pixel at the position P4 are controlled on the q4-fold, with q4=85/94. For pixels between two positions the q-values are interpolated. In this way, all the pixels of the first 12 and second 14 monitors show the same brightness, which corresponds with maximum control of the maximum brightness of the pixel at the position P3.

For each position, and at least for the positions P1 and P2, a large number of values measured for the light quantum, meaning brightness, are recorded. Therefore, the screen will be set to display a brightness level, and the sensor captures the real brightness levels displayed by the screen. In various embodiments, for each position, a curve plotting the brightness levels displayed to the set brightness level is generated. The curves will then be correlated such as to obtain a curve that renders the measured brightness in position P1 as a function of the measured brightness in position P2.

In various embodiments, the use of a monitor 12 will result in a uniform aging over the entire screen. Thus, this ‘aging’ process leads to the ratio of the magnitudes of displayed brightness at P1 and P2 to remain constant. Therefore, in various embodiments, the sensor 26 is attached to the frame 22 so as to enable the measurement of brightness at position P2. Using the aforementioned ratio and correlation curve, the brightness settings may be adjusted for position P1, at the center of the screen. This way, we can compensate the aging of the center of the screen 36 by measuring and adjusting the brightness levels from the margins of the screen 36.

In various embodiments the above process can be performed with brightness values. In other embodiments the color homogeneity of the first 12 and second 14 monitors can be adjusted by displaying, only one color, such as red, green, or blue on the screen 36.

In another embodiment, we will use the sensor 26 to measure a red brightness, a green brightness, a blue brightness, a white brightness and a black brightness. Thus, from all measured positions, target gamut is identified that can be rendered at any position. Accordingly, in order to display an image on one or both screens, the images data will be normalized according to the target gamut.

FIG. 7 presents how you can obtain a target gamut from two gamuts for values measured as CIE/x/y/Y on both a first 12 and second 14 monitor's screens 36 according to one embodiment. In order to keep track of the first 12 and second 14 monitor's aging process, the pixels around the sensor 26 fixed on the frame 22 will be activated at regular intervals such as to maintain correct functioning. In various embodiments, correct functioning of the pixels would render a certain measured value of the light quantum. This light quantum, for example brightness, will be measured by the sensor 26. If the value of the light quantum deviates too much from the set value, a new measurement of the uniformity will be performed. In certain embodiments, regular checkups of the monitors' aging can be triggered remotely using a command sent from a server 20. Further, in certain embodiments, the remote trigger may be sent through the internet.

1. A sensor for measuring the light intensity comprising:
a light sensor; and
an assembling device for attaching and allowing the dismantling of the sensor to a monitor;
wherein the sensor measures the light intensity (I) generated by the monitor's screen.

2. The sensor of claim 1 wherein the assembling device connects to a monitor through mould-based connection or magnetic connection.

3. The sensor of claim 1 wherein the assembling device attaches to a monitor's frame.

4. The sensor of claim 1 further comprising a light shield wherein the light shield shields stray light emitting form the monitor.

5. The sensor of claim 1 further comprising:
a linking device; and
an electronic control device;
wherein the linking device transmits the measurement data of light intensity to the electronic control device and has an operating radius that is large enough as to allow the positioning of the sensor on any part of the monitor's screen.

6. The sensor of claim 5 wherein the electronic control device comprises instructions adapted to determine a screen factor for screening radial fascicles detected by a sensor.

7. A monitor comprising:
a screen for displaying images; and
a light sensor;
wherein the light sensor measures light intensity of the screen and is detachably mounted to the screen.

8. The monitor of claim 7, further comprising a frame which encloses the screen at least partially wherein the sensor is attached in one of the frame's corners.

9. The monitor of claim 7 wherein the sensor's operating radius corresponds to at least the width of the screen.

10. The monitor of claim 7 therein the sensor covers a percentage of the screen that is lower than a hundredth of a total screen area.

11. The monitor of claim 7 further comprising a positioning device for automatically attaching the sensor on a pre-established position on the screen.

12. A display device comprising:
a first monitor;
a second monitor; and
a light sensor releasably attached to the first and second monitor.

13. The display device of claim 11, further comprising an electric control device releasably attached to the first monitor, second monitor and light sensor adapted to perform the steps of:
displaying images on a screen of the first or the second monitor;
capturing a signal from a sensor as a function of time;
determining the position of the sensor relative to the screen of the first or the second monitor from the signal; and
measuring at least one light intensity data element generated by the screen at the first position;
wherein the steps are repeated for at least two additional positions, in order to obtain the screen's emission pattern.

14. The display device of claim 12 wherein the sensor is selected from the group consisting of a brightness sensor, primary color sensor or a spectral diffusion sensor.

15. The display device of claim 12 wherein the operating radius of the sensor is the screen area of the first and second monitors.

16. A method for adjusting monitor display settings comprising:
positioning a sensor on a screen of a monitor at a first position;
displaying an image on the screen of the monitor;
capturing the sensor's signal response to the image in relation to time;
determining the first position of the sensor according to the sensor's signal; and
measuring at least one light intensity data element generated by the screen at the first position.

17. The method of claim 16 wherein the steps are repeated for at least two additional positions, in order to obtain the screen's emission pattern.

18. The method of claim 16 wherein the emission pattern represents a brightness uniformity of the screen.

19. The method of claim 16 further comprising:
determining a minimum value of all light intensity data elements; and
adjusting the monitor display settings according to the minimum value.

20. The method of claim 19 wherein adjusting the monitor display settings according to the minimum value comprises normalizing the monitor display settings for a pixel brightness to the minimum in order to diminish the screen's lack of uniformity.

21. The process of claim 16 wherein measuring a light intensity data element generated by the screen at the first position comprises measuring light intensity data of a red light, a green light, a blue light, a white light and a black light thereby identifying a target-color gamut.

21. The process of claim 20 further comprising normalizing the values of the display setting for the screen according to the identified target-color gamut wherein the normalized values allow the screen to displaying uniform coloring.

22. The process of claim 16 further comprising:
positioning the sensor on a screen of the monitor at a second position;
displaying an image on the screen of the monitor;
capturing the sensor's signal response to the image in relation to time;
determining the second position of the sensor according to the sensor's signal;
measuring at least one light intensity data element generated by the screen at the second position; and
correlating the light intensity data element measurement from the second position and the light intensity data element measurement from the first position, wherein the first position is in the center of the monitor screen and the second position is near the edge of the monitor screen.

23. The process of claim 22 further comprising:
measuring of the light intensity data element in the second position using the sensor; and
controlling the monitor based on the correlation thereby adjusting for any deviation of light intensity at the center of the monitor screen.
